(19) United States
(12) Patent Application Publication
(10) Pub. No.: US 2021/0303263 A1
(43) Pub. Date: Sep. 30, 2021

(54) DIALOGUE SYSTEM AND VEHICLE HAVING THE SAME, AND METHOD OF CONTROLLING DIALOGUE SYSTEM

(71) Applicants: Hyundai Motor Company, Seoul (KR); Kia Motors Corporation, Seoul (KR)

(72) Inventors: Seona Kim, Seoul (KR); Youngmin Park, Seoul (KR); Jeong-Eom Lee, Yongin (KR)

(21) Appl. No.: 17/087,114

(22) Filed: Nov. 2, 2020

(30) Foreign Application Priority Data
Mar. 26, 2020 (KR) 10-2020-0036791

(51) Int. Cl. G06F 3/16; G10L 15/26; B60R 16/023; B60W 50/10

(52) U.S. Cl. CPC G06F 3/167; G10L 15/26; B60W 2540/21; B60W 50/10; B60R 16/0231

(57) ABSTRACT

A vehicle includes a first input device that receives a speech signal; a second input device that receives user input, vehicle state information, driving environment information, or user information; a storage that stores text corresponding to each of a plurality of speech signals and information about a standard language corresponding to each text; and a dialogue system that converts the received speech signal into text of the standard language based on the information stored in the storage, to identify an intention of the user's utterance based on the converted text, to determine the user's context based on at least one information received by the second input device, to determine an action corresponding to the identified intention of the user's utterance and the determined user's context, to generate a response corresponding to the determined action, and to output the generated response.

### CROSS-REFERENCE TO RELATED APPLICATION(S)

This application claims under 35 U.S.C. § 119 the benefit of Korean Patent Application No. 10-2020-0036791, filed on Mar. 26, 2020 in the Korean Intellectual Property Office, the entire contents of which are incorporated by reference herein.

### BACKGROUND

### (a) Technical Field

The disclosure relates to a dialogue system that recognizes a user's intention through dialogue with a user and that provides information or a service needed by the user, a vehicle having the same, and a method of controlling the dialogue system.

### (b) Description of the Related Art

For an audio-video-navigation (AVN) device of a vehicle, an air conditioner in the vehicle, or most mobile devices, when providing visual information to a user or receiving a user's input, a small screen and a small button provided therein may cause the user inconvenience.

In particular, during driving of the vehicle, when a user moves his or her hand off a steering wheel or when for the user looks up to check visual information or operate devices in the vehicle, it may be a serious danger to the safe driving.

Therefore, when applying a dialogue system to a vehicle, it may be possible to provide services in a more convenient and safer manner, where the dialogue system is capable of recognizing a user's intention through dialogue with the user and provide information or a service desired for the user.

### SUMMARY

An aspect of the disclosure is to provide a dialogue system that recognizes a user's intention and speech, recognizes an inaccurate pronunciation speech as an accurate pronunciation speech based on the recognized user's intention and speech, and controls the operation of at least one device based on the recognized speech, a vehicle having the same, and a method of controlling the dialogue system.

Another aspect of the disclosure is to provide a dialogue system that recognizes the user's intention and speech and recognizes a nonstandard language as a standard language based on the recognized user's intention and speech, a vehicle having the same, and a method of controlling the dialogue system.

Additional aspects of the disclosure will be set forth in part in the description which follows and, in part, will be obvious from the description, or may be learned by practice of the disclosure.

In accordance with an aspect of the disclosure, a dialogue system includes a storage configured to store information about a standard language corresponding to a nonstandard language and a language of inaccurate pronunciation; a speech recognizer configured to receive a speech signal, to convert the received speech signal into text, and to correct the converted text into text of the standard language based on information stored in the storage when it is determined that the converted text corresponds to the nonstandard language or the inaccurate pronunciation; and a result processor configured to generate a response corresponding to the corrected text by the speech recognizer, and to control an output of the generated response.

The dialogue system may further include a first input device configured to receive the speech signal. The storage may be configured to store information about text corresponding to a plurality of speech signals. The speech recognizer may be configured to convert the received speech signals into text based on information stored in the storage.

The dialogue system may further include a natural language understanding portion configured to identify an intention of a user's utterance based on the text converted by the speech recognizer, and to determine an action corresponding to the identified intention of the user's utterance. When it is determined that the action is not determined in the natural language understanding portion, the speech recognizer may be configured to identify similarities between the received speech signal and the plurality of speech signals stored in the storage, respectively, and to identify text corresponding to the speech signal higher than a certain similarity among the identified similarities.

The dialogue system may further include a natural language understanding portion configured to identify an intention of a user's utterance based on the text converted by the speech recognizer, and to determine an action corresponding to the identified intention of the user's utterance. When it is determined that the action is not determined in the natural language understanding portion, the speech recognizer may be configured to identify similarities between the received speech signal and the plurality of speech signals stored in the storage, respectively, and to identify text corresponding to the speech signal having the highest similarity among the identified similarities. The dialogue system may further include a natural language understanding portion configured to identify an intention of a user's utterance based on the text corrected by the speech recognizer, and to determine an action corresponding to the identified intention of the user's utterance. The result processor may be configured to generate a response corresponding to the determined action, and to convert text corresponding to the generated response into the speech signal.

The dialogue system may further include a second input device configured to receive at least one of user input, vehicle state information, driving environment information, or user information; a situation information processor configured to determine the user's context based on at least one information received by the second input device; and a natural language understanding portion configured to identify an intention of a user's utterance based on the text corrected by the speech recognizer, and to determine an action corresponding to the identified intention of the user's utterance and the user's context. The result processor may be configured to generate a response corresponding to the determined action, and to convert text corresponding to the generated response into the speech signal.

The speech recognizer may be configured to determine whether the converted text corresponds to the nonstandard language or the inaccurate pronunciation based on the identified intention of the user's utterance and the user's context.

In accordance with an aspect of the disclosure, a vehicle includes a first input device configured to receive a speech signal; a second input device configured to receive at least one of user input, vehicle state information, driving environment information, or user information; a storage configured to store text corresponding to each of a plurality of speech signals and information about a standard language corresponding to each text; and a dialogue system configured to convert the received speech signal into text of the standard language based on the information stored in the storage, to identify an intention of the user's utterance based on the converted text, to determine the user's context based on at least one information received by the second input device, to determine an action corresponding to the identified intention of the user's utterance and the determined user's context, to generate a response corresponding to the determined action, and to output the generated response. The text corresponding to each of the plurality of speech signals may include text in the standard language, text in a nonstandard language, and text in a language of inaccurate pronunciation.

The vehicle may further include a display configured to output the generated response as an image; and a speaker configured to output the generated response as audio.

The vehicle may further include a controller configured to control at least one of an air conditioner, windows, doors, seats, an audio/video/navigation (AVN), a heater, a wiper, side mirrors, internal lamps, or external lamps in response to the response output from the dialogue system.

When it is determined that the action has not been determined, the dialogue system may be configured to identify similarities between the received speech signal and the plurality of speech signals stored in the storage, respectively, to identify text corresponding to the speech signal higher than a certain similarity among the identified similarities, and to determine the action for the identified text.

The dialogue system may be configured to store information about the determined action and the identified text in the storage when the action for the identified text is determined.

The dialogue system may be configured to store information about the determined action and the converted text in the storage when an action for the converted text is determined.

In accordance with an aspect of the disclosure, a method of controlling a dialogue system includes receiving a speech signal; converting the received speech signal into text in standard language based on information stored in a storage; identifying an intention of the user's utterance based on the converted text; determining an action corresponding to the identified intention of the user's utterance and the converted text; generating a response corresponding to the determined action; and outputting the generated response as the speech signal. The information stored in the storage may be information about text corresponding to each of a plurality of speech signals and standard language corresponding to each text. The text corresponding to each of the plurality of speech signals may include text in the standard language, text in a nonstandard language, and text in a language of inaccurate pronunciation.

The determining of the action may include receiving at least one of user input, vehicle state information, driving environment information, or user information; determine the user's context based on the received at least one information; identifying the intention of the user's utterance based on the converted text; and determining the action corresponding to the identified intention of the user's utterance and the determined user's context.

The method may further include when it is determined that the action has not been determined, identifying similarities between the received speech signal and the plurality of speech signals stored in the storage, respectively; identifying text corresponding to the speech signal higher than a certain similarity among the identified similarities; determining the action for the identified text; and storing information about the determined action and the identified text in the storage when the action for the identified text is determined.

The generating of the response may include generating the response to control at least one of an air conditioner, windows, doors, seats, an audio/video/navigation (AVN), a heater, a wiper, side mirrors, internal lamps, or external lamps provided in a vehicle.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating an interior of a vehicle provided with a dialogue system according to an embodiment.

FIG. 2 is a control configuration diagram of a vehicle provided with a dialogue system according to an embodiment.

FIG. 3 is a detailed configuration diagram of a dialogue system according to an embodiment.

FIG. 4 is a detailed configuration diagram of an input processor of a dialogue system according to an embodiment.

FIG. 5 is a detailed configuration diagram of a dialogue manager of a dialogue system according to an embodiment.

FIG. 6 is a detailed configuration diagram of a result processor of a dialogue system according to an embodiment.

FIG. 7 is a control flowchart of a dialogue system according to an embodiment.

FIG. 8 is a flowchart of learning control of a dialogue system according to an embodiment.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, the operating principles and some forms of the disclosure will be described with reference to the accompanying drawings.

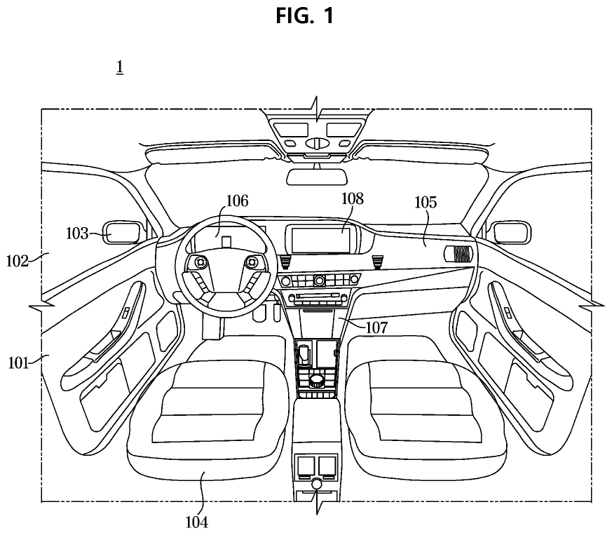

FIG. 1 is a view illustrating an interior of a vehicle provided with a dialogue system according to an embodiment.

A vehicle 1 may include a body with exterior and interior parts, and a chassis, which is a part of the vehicle 1 except for the body, on which mechanical devices required for driving are installed.

The exterior parts of the body may include front, rear, left and right doors 101, window glasses 102 (or windows) installed on the front, rear, left and right doors 101, and a side mirror 103 that provides a driver of the vehicle 1 with a field of view behind the vehicle 1.

The interior parts of the body may include seats 104 for passengers to sit thereon, a dashboard 105, an instrument panel 106 (i.e., a cluster) placed on the dashboard 105 and equipped with a tachometer, a speedometer, a coolant thermometer, a fuel gauge, a turn indicator, a high light indicator, a warning light, a seat belt warning light, an odometer, an automatic shift selector light, a door open warning light, an engine oil warning light, a fuel shortage warning light, and a center fascia 107 with a throttle for an audio and a heater air conditioner.

The center fascia 107 may be equipped with a vent, a lighter, an audio/video/navigation (AVN) device 108, or the like.

The AVN device 108 may calculate a current position of the vehicle 1 based on position information provided by a plurality of satellites, and display the current position by matching a map.

In addition, the AVN device 108 may receive a destination from a user, perform route search from the current position to a destination based on a route search algorithm, display the searched route by matching the map, and guide the user to the destination along the route.

The AVN device 108 may receive an operation command through speech recognition, or an address to a destination through speech recognition, and select any one of a plurality of previously stored addresses through speech recognition.

The chassis of the vehicle 1 further includes a power generation device, a power transmission device, a traveling device, a steering device, a braking device, a suspension device, a transmission device, a fuel device, front and rear wheels, and the like.

In addition, various safety devices are provided in the vehicle 1 for the safety of occupants. Vehicle stabilization devices may include various types of safety, such as an airbag control device in the event of a vehicle collision, and an electronic stability control device (ESC) that controls the vehicle's posture during acceleration or cornering of the vehicle 1.

The vehicle 1 may further include a sensing device, such as a proximity sensor for detecting an obstacle or another vehicle in the rear or sides of the vehicle 1, a rain sensor for detecting rainfall and the amount of rainfall, and the like.

In addition, the vehicle 1 may selectively include an electronic device (i.e., a load), such as a hands-free device, a global positioning system (GPS), an audio device, a Bluetooth device (that is, a communication device), a rear camera, a charging device, a black box, a heating wire of a seat, a high pass device, and the like. The electronic device may receive the operation command through speech recognition.

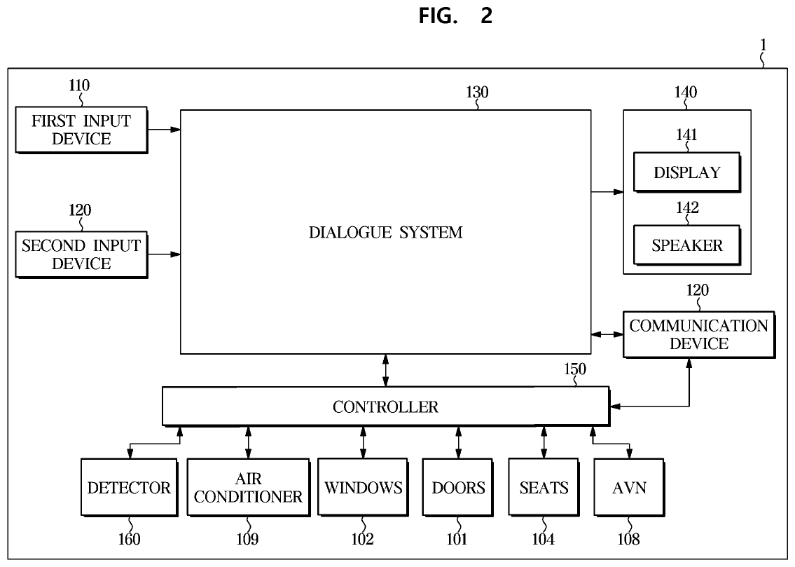

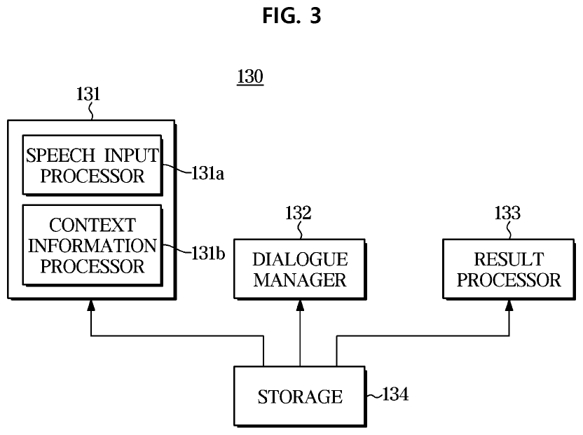

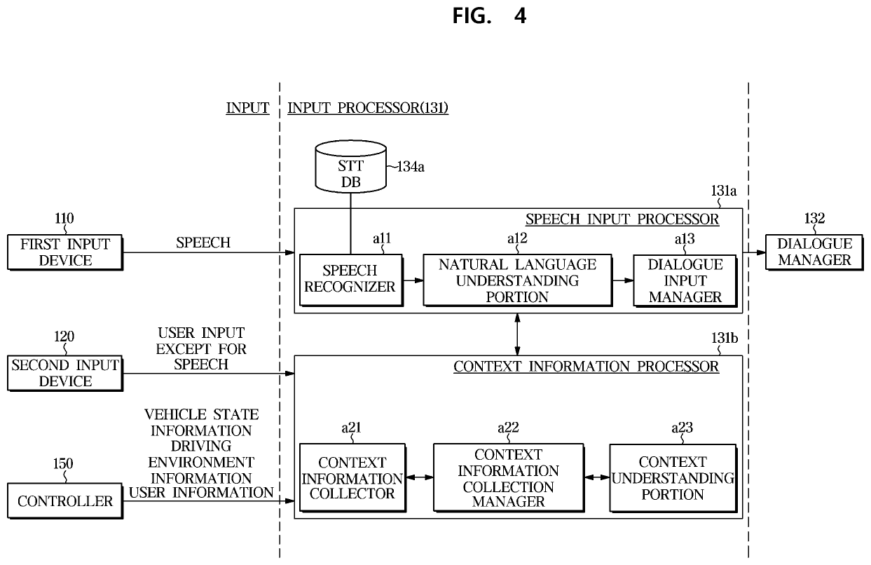

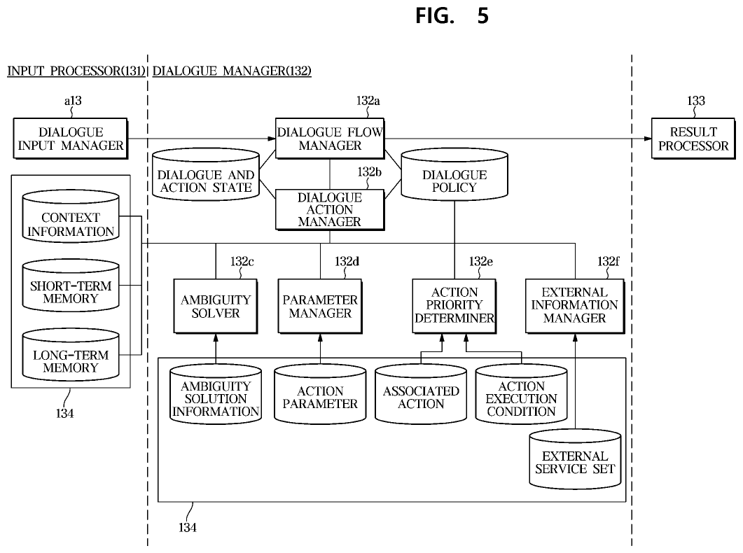

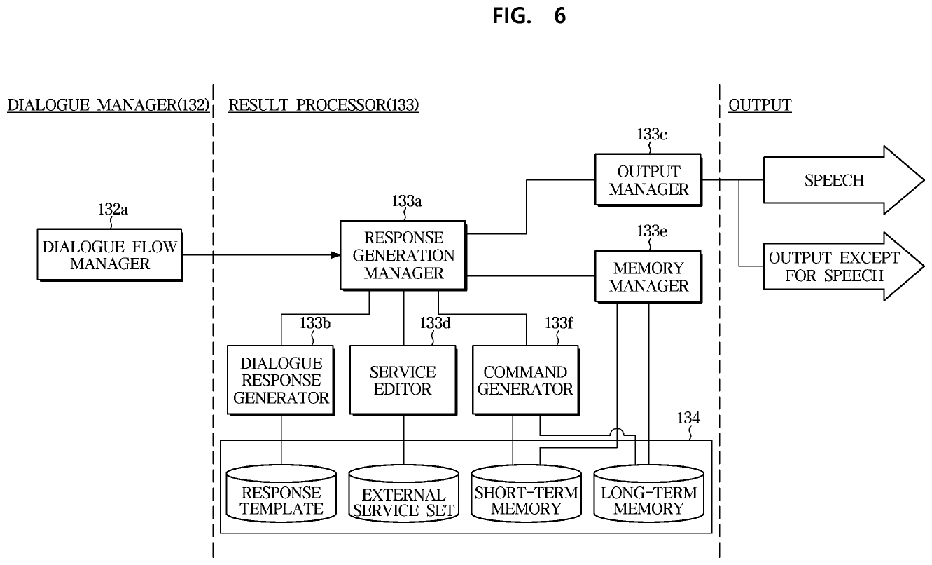

FIG. 2 is a control configuration diagram of a vehicle provided with a dialogue system according to an embodiment, FIG. 3 is a detailed configuration diagram of a dialogue system according to an embodiment, FIG. 4 is a detailed configuration diagram of an input processor of a dialogue system according to an embodiment, FIG. 5 is a detailed configuration diagram of a dialogue manager of a dialogue system according to an embodiment, and FIG. 6 is a detailed configuration diagram of a result processor of a dialogue system according to an embodiment.

Referring to FIG. 2, the vehicle 1 may include a first input device 110, a second input device 120, a dialogue system 130, an output device 140, a controller 150, a detector 160, a communication device 170, and a plurality of electronic devices 101, 102, 104, 108, and 109.

The first input device 110 may receive a user control command as a speech. The first input device 110 may include a microphone configured to receive a sound and then covert the sound into an electrical signal.

For the effective speech input, the first input device 110 may be mounted to a head lining, but the first input device 110 may be mounted to the dashboard 105 or a steering wheel. In addition, the first input device 110 may be mounted to any position as long as a position is appropriate for receiving the user's speech.

The second input device 120 may receive the user command through user manipulation. The second input device 120 may include at least one of buttons, keys, switches, touch pads, pedals, or levers.

The second input device 120 may also include a camera that captures the user. The user's gesture, facial expression or gaze direction used while inputting a command may be recognized through an image captured by the camera. Alternatively, it is also possible to grasp the user's state (such as drowsiness) through the image captured by the camera.

The second input device 120 may be implemented as a touch panel, and the display 141 of the output device 140 may be implemented as a flat panel display panel such as an LCD. That is, the display 141 of the second input device 120 and the output device 140 may be implemented as a touch screen in which the touch panel and the flat panel display panel are integrally formed.

The second input device 120 may further include a jog dial (not shown) for inputting a movement command and a selection command of a cursor displayed on the display 141.

The second input device 120 may transmit a signal for the buttons or jog dial operated by the user to the controller 150, and also transmit a signal of a position touched by the touch panel to the controller 150.

The dialogue system 130 may recognize the user's intention and context using the user's speech input via the first input device 110, the input except for the user's speech, input via the second input device 120, and a variety of information input via the controller 150. The dialogue system 130 may output a response to perform an action corresponding to the user's intention.

The dialogue system 130 may convert the user speech input through the first input device 110 into text, and determine whether the converted text is text for an inaccurate pronunciation or text for a nonstandard language based on the converted text and the user's intention and context.

The dialogue system 130 may correct the converted text to text for accurate pronunciation based on the user's intention and context when it is determined that the converted text is text for the inaccurate pronunciation, and the converted text is text for a nonstandard language. When it is determined that the converted text is text for the nonstandard language, the dialogue system 130 may correct the converted text to the text for a standard language based on the user's intention and context.

The dialogue system 130 may output the response for performing the action on the corrected text based on the corrected text, the user's intention and context.

Vehicle information input through the controller 150 may include vehicle state information or surrounding context information obtained through various sensors of the detector 160 provided in the vehicle 1, and may also include information basically stored in the vehicle 1, such as the type of vehicle.

The dialogue system 130 may recognize the user's real intention and proactively provide information corresponding to the intention by considering a content, which is not uttered by the user, based on pre-obtained information. Therefore, it may be possible to reduce the dialogue steps and time for providing the service desired by the user.

As illustrated in FIG. 3, the dialogue system 100 may include an input processor 131, a dialogue manager 132, a result processor 133, and a storage 134.

The input processor 131 may process a user input including the user's speech and input except for the speech, information related to the vehicle 1, or input including information related to the user.

The input processor 131 may receive two kinds of input such as a user speech and an input except for the speech. The input except for the speech may include recognizing user's gesture, an input except for the user's speech input by operations of the input devices 110 and 120, the vehicle state information indicating a vehicle state, driving environment information related to driving information of the vehicle 1 and user information indicating user's state. In addition, other than the above mentioned information, information related to the user and the vehicle 1 may be input to the input processor 131, as long as information is used for recognizing a user's intention or providing a service to a user or the vehicle 1. The user may include vehicle occupant(s) such as the driver and passenger(s).

The input processor 131 may convert the user's speech into an utterance in the text type by recognizing the user's speech and recognize the user's intention by applying natural language understanding algorithm to the user utterance.

The input processor 131 may collect information related to the vehicle state or the driving environment of the vehicle other than the user speech, and then understand the context using the collected information.

The input processor 131 may transmit the user's intention, which is obtained by the natural language understanding technology, and the information related to the context to the dialogue manager 132. The dialogue manager 132 may use the processing result of the input processor 131 to grasp the user's intention or the vehicle state, and determine the action corresponding to the user's intention or the vehicle state.

The dialogue manager 132 may determine the action corresponding to the user's intention or the current context based on the user's intention, the relationship between the speakers, the information related to the context transmitted from the input processor 131, and manage parameters that are needed to perform the corresponding action.

According to forms, the action may represent all kinds of actions for providing a certain service, and the kinds of the action may be determined in advance.

The dialogue manager 132 may transmit information related to the determined action to the result processor 133.

The result processor 133 outputs a system utterance for continuing the dialogue or providing a specific service according to the output result of the dialogue manager 132.

The result processor 133 generates and outputs a dialogue response and a command that is needed to perform the transmitted action. The dialogue response may be output in text, image or audio type. When the command is output, a service such as vehicle control and external content provision, corresponding to the output command, may be performed.

The storage 134 may store various information necessary for the dialogue system 130 to perform various operations.

The storage 134 may store a variety of information for the dialogue processing and the service provision. For example, the storage 134 may pre-store information related to domains, actions, speech acts and entity names used for the natural language understanding and a context understanding table used for understanding the context from the input information. In addition, the storage 140 may pre-store data detected by a sensor provided in the vehicle, information related to a user, and information needed for the action.

The storage 134 may include an STT (Speech To Text) DB, a domain/action inference rule DB, and the domain/action inference rule DB may include predefined actions such as road guidance, vehicle condition check, gas station recommendation, and the like. Accordingly, the action corresponding to the user's utterance, that is, an action intended by the user, may be extracted from predefined actions.

In addition, the storage 134 may include an associated action DB that stores actions associated with events occurring in the vehicle 1.

As mentioned above, the dialogue system 130 may provide dialogue processing technologies that are proper for vehicle environments. All components or some components of the dialogue system 130 may be contained in the vehicle 1.

When applying the dialogue processing technologies appropriate for the vehicle environments, such as the dialogue system 130, it may easily recognize and respond to a key context by which the driver directly drives the vehicle. It may be possible to provide a service by applying a weight to a parameter affecting the driving, such as gasoline shortages and drowsy driving, or it may be possible to easily obtain information, e.g., a driving time and destination information, which is needed for the service, based on a condition in which the vehicle 1 moves to the destination in most cases.

The detailed configuration of the dialogue system 130 will be described later with reference to FIGS. 4, 5, and 6.

The output device 140 is a device configured to provide an output in a visual, auditory or tactile manner, to a talker. The output device 140 may include the display 141 and the speaker 142 provided in the vehicle 1.

The display 141 and the speaker 142 may output the response to the user's utterance, a question about the user, or information requested by the user, in the visual or auditory manner. In addition, it may be possible to output a vibration by installing a vibrator in the steering wheel.

The display 141 may be implemented by any one of various display devices, e.g., Liquid Crystal Display (LCD), Light Emitting Diode (LED), Plasma Display Panel (PDP), Organic Light Emitting Diode (OLED), and Cathode Ray Tube (CRT).

The display 141 may display a map related to driving information, road environment information, and route guidance information according to the instructions of the controller 150. That is, the display 141 may display the map in which the current position of the vehicle 1 is matched, the operation state, and other additional information.

The display 141 may display information related to a telephone call or information related to music reproduction, and may also display an external broadcast signal as the image.

The display 141 may also display a dialogue screen in a dialogue mode.

The speaker 142 may dialogue with the user inside the vehicle 1 or output the sound necessary for providing the service desired by the user.

The speaker 142 may output a speech for navigation route guidance, the sound or the speech contained in the audio and video contents, the speech for providing information or service desired by the user, and a system utterance generated as a response to the user's utterance.

Further, according to the response output from the dialogue system 130, the controller 150 may control the vehicle 1 to perform the action corresponding to the user's intention or the current context.

Meanwhile, as well as the information obtained by the detector 160 provided in the vehicle 1, the vehicle 1 may collect information acquired from an external content server or an external device via the communication device 170, e.g., driving environment information and user information such as traffic conditions, weather, temperature, passenger information and driver personal information, and then the vehicle 1 may transmit the information to the dialogue system 130.

Information obtained by the detector 160 provided in the vehicle 1, e.g., a remaining amount of fuel, an amount of rain, a rain speed, surrounding obstacle information, a speed, an engine temperature, a tire pressure, current position, may be input to the dialogue system 130 via the controller 150.

According to the response output from the dialogue system 130, the controller 150 may control the air conditioner 109, windows 102, doors 101, the seats 104 or the AVN 108 provided in the vehicle 1. In addition, the controller 150 may control at least one of the audio, a heater, a wiper, the side mirror, or interior and exterior lamps according to the response output from the dialogue system 130.

The controller 150 may include a memory in which a program for performing the above-described operation and the operation described later is stored, and a processor for executing the stored program. At least one memory and one processor may be provided, and when a plurality of memory and processors are provided, they may be integrated on one chip or physically separated.

The detector 160 may include a plurality of sensors, and transmit the vehicle state information or the driving environment information such as the remaining amount of fuel, rainfall, rainfall speed, surrounding obstacle information, tire pressure, current position, engine temperature, vehicle speed, etc., detected by the plurality of sensors to the controller 150.

The communication device 170 may include at least one communication module configured to communicate with internal and external devices of the vehicle 1. For example, the communication device 170 may include at least one of a short-range communication module, a wired communication module, or a wireless communication module.

The short-range communication module may include a variety of short range communication modules, which is configured to transmit and receive a signal using a wireless communication module in the short range, e.g., Bluetooth module, Infrared communication module, Radio Frequency Identification (RFID) communication module, Wireless Local Access Network (WLAN) communication module, NFC communications module, and ZigBee communication module.

The wired communication module may include a variety of wired communication module, e.g., Local Area Network (LAN) module, Wide Area Network (WAN) module, or Value Added Network (VAN) module and a variety of cable communication module, e.g., Universal Serial Bus (USB), High Definition Multimedia Interface (HDMI), Digital Visual Interface (DVI), recommended standard 232 (RS-232), power line communication or plain old telephone service (POTS).

The wireless communication module may include a wireless communication module supporting a variety of wireless communication methods, e.g., Wifi module, Wireless broadband module, global System for Mobile (GSM) Communication, Code Division Multiple Access (CDMA), Wideband Code Division Multiple Access (WCDMA), Time Division Multiple Access (TDMA), Long Term Evolution (LTE), 4G and 5G.

In addition, the communication device may further include an internal communication module for communication between electronic devices in the vehicle 1. The communication protocol of the vehicle 1 may use Controller Area Network (CAN), Local Interconnection Network (LIN), FlexRay, and Ethernet.

As illustrated in FIG. 4, the input processor 131 may include a speech input processor 131a and a context information processor 131b.

The speech input processor 131a may include a speech recognizer a11, a natural language understanding portion a12, and a dialogue input manager a13.

The speech recognizer a11 may output the utterance in the text type by recognizing the input user's speech. The speech recognizer a11 may include a speech recognition engine and the speech recognition engine may recognize a speech uttered by a user by applying a speech recognition algorithm to the input speech and generate a recognition result.

Since the input speech is converted into a more useful form for the speech recognition, the speech recognizer a11 may detect an actual speech section included in the speech by detecting a start point and an end point from the speech signal. This is called End Point Detection (EPD).

The speech recognizer a11 may extract the feature vector of the input speech from the detected section by applying the feature vector extraction technique, e.g., Cepstrum, Linear Predictive Coefficient: (LPC), Mel Frequency Cepstral Coefficient (MFCC) or Filter Bank Energy.

The speech recognizer a11 may acquire the results of recognition by comparing the extracted feature vector with a trained reference pattern. At this time, the speech recognizer a11 may use an acoustic model of modeling and comparing the signal features of a speech, and a language model of modeling a linguistic order relation of a word or a syllable corresponding to a recognition vocabulary. For this, the storage 134 may store the acoustic model and language model DB.

The acoustic model may be classified into a direct comparison method of setting a recognition target to a feature vector model and comparing the feature vector model to a feature vector of a speech signal, and a statistical method of statistically processing a feature vector of a recognition target.

The speech recognizer a11 may use any one of the above-described methods for the speech recognition. For example, the speech recognizer a11 may use an acoustic model to which the HMM is applied, or a N-best search method in which an acoustic model is combined with a speech model. The N-best search method may improve recognition performance by selecting N recognition result candidates or less using an acoustic model and a language model, and then re-estimating an order of the recognition result candidates.

The speech recognizer a11 may calculate a confidence value to ensure reliability of a recognition result. A confidence value may be criteria representing how a speech recognition result is reliable. For example, the confidence value may be defined, with respect to a phoneme or a word that is a recognized result, as a relative value of probability at which the corresponding phoneme or word has been uttered from different phonemes or words. Accordingly, a confidence value may be expressed as a value between 0 and 1 or between 1 and 100.

When the confidence value is greater than a predetermined threshold value, the speech recognizer 111a may output the recognition result to allow an operation corresponding to the recognition result to be performed. When the confidence value is equal to or less than the threshold value, the speech recognizer a11 may reject the recognition result. The speech recognizer a11 may be corrected as the utterance in the text type corresponding to the user's intention and context based on the information stored in a STT DB 134a, rather than to understand the utterance in the text type by the speech recognizer a11 as it is.

Here, the STT DB 134a may be provided in the storage 134.

The STT DB 134a may store information about texts respectively matched to a plurality of speech signals. The text may include languages of standard language, nonstandard language and inaccurate pronunciation.

The language of inaccurate pronunciation may be not the standard language or the nonstandard language, but it may be a language that many people use in common.

The language of inaccurate pronunciation may include a language pronounced with a similar consonant or a similar vowel, for example.

The STT DB 134a may store at least one speech signal corresponding to text having the same meaning.

For example, a speech signal of the standard language, a speech signal of the nonstandard language, and a speech signal of the inaccurate pronunciation may be stored for one standard language. For example, for the standard language ‘turn on’, the speech signal of the standard language ‘turn on’ and the speech signals of the nonstandard languages ‘turn on’ and ‘kida’ may be stored.

In the STT DB 134a, the standard language corresponding to the nonstandard language may be matched and stored, or the standard language corresponding to the language of inaccurate pronunciation may be matched and stored. For example, the nonstandard languages ‘turn on’ and ‘kida’ may be stored for the standard languages ‘turn on’.

The STT DB 134a may store text corresponding to the plurality of speech signals and information about the standard language corresponding to each text. In this case, text corresponding to the plurality of speech signals may include text for the standard language, text for the nonstandard language, and text for inaccurate pronunciation. The speech recognizer a11 may determine whether the converted text is text for inaccurate pronunciation or nonstandard language based on the converted text, the user's intention and context. When it is determined that the converted text is text for inaccurate pronunciation, the speech recognizer a11 may correct the converted text to text for accurate pronunciation based on the user's intention and context. When it is determined that the converted text is text for nonstandard language, the speech recognizer a11 may correct the converted text to text for standard language based on user's intention and context.

The speech recognizer a11 may include a STT module that accurately recognizes the action.

The speech recognizer a11 may receive information from the STT DB 134a for converting speech to text, and update information stored in the STT DB 134a based on the speech recognition result.

The speech recognizer a11 may identify a similarity level between the speech signal in the STT DB 134a and the received speech signal, and identify at least one speech signal having the similarity level above a certain level among the identified similarities, and identify texts corresponding to at least one speech signal.

The speech recognizer a11 may select one text corresponding to the user's intention and context from the identified texts.

The speech recognizer a11 may receive the speech signal, convert the received speech signal to text. When it is determined that the converted text is not the standard language, the speech recognizer a11 may identify the nonstandard language or inaccurate pronunciation language corresponding to the converted text, identify the standard language corresponding to the language of nonstandard language or inaccurate pronunciation based on the information stored in the STT DB 134a among the storage 134, and correct the converted text with the text of the identified standard language.

The speech recognizer a11 may determine that the converted text corresponds to the nonstandard language or the inaccurate pronunciation when no action corresponding to the converted text is detected.

The speech recognizer a11 may determine that the converted text corresponds to the nonstandard language or the inaccurate pronunciation when the converted text is out of the user's intention and context.

The speech recognizer a11 may perform STT learning based on the recognition result of speech and update information in the STT DB 134a based on the learning result.

The speech recognizer a11 may also set STT conversion parameters based on the speech recognition result in a state where the user's intention or context is not analyzed, and store the set STT parameters in the STT DB 134a.

The speech recognizer a11 may improve the vocabulary comprehension of the speech uttered by the user, and accurately grasp the user's intention.

The utterance in the text type that is the recognition result of the speech recognizer all may be input as the natural language understanding portion a12.

The natural language understanding portion a12 may apply a natural language understanding technology to the utterance to grasp the user's intention contained in the utterance.

The natural language understanding portion a12 may identify an intention of user's utterance included in an utterance language by applying the natural language understanding technology. Therefore, the user may input a control command through a natural dialogue, and the dialogue system 130 may also induce the input of the control command and provide a service needed the user via the dialogue.

The natural language understanding portion a12 may perform morphological analysis on the utterance in the form of text. A morpheme is the smallest unit of meaning and represents the smallest semantic element that can no longer be subdivided. Thus, the morphological analysis is a first step in natural language understanding and transforms the input string into the morpheme string.

The natural language understanding portion a12 may extract a domain from the utterance based on the morphological analysis result. The domain may be used to identify a subject of a user utterance language, and the domain indicating a variety of subjects, e.g., route guidance, weather search, traffic search, schedule management, fuel management and air conditioning control, may be stored as a database.

The natural language understanding portion a12 may recognize an entity name from the utterance. The entity name may be a proper noun, e.g., people names, place names, organization names, time, date, and currency, and the entity name recognition may be configured to identify an entity name in a sentence and determine the type of the identified entity name. The natural language understanding portion a12 may extract important keywords from the sentence using the entity name recognition and recognize the meaning of the sentence.

The natural language understanding portion a12 may analyze a speech act contained in the utterance. The speech act analysis may be configured to identify the intention of the user utterance, e.g., whether a user asks a question, whether a user asks a request, whether a user responds or whether a user simply expresses an emotion.

The natural language understanding portion a12 extracts an action corresponding to the intention of the user's utterance. The natural language understanding portion a 12 may identify the intention of the user's utterance based on the information, e.g., domain, entity name, and speech act and extract an action corresponding to the utterance. The action may be defined by an object and an operator.

The natural language understanding portion a12 may extract a parameter related to the action execution. The parameter related to the action execution may be an effective parameter that is directly required for the action execution, or an ineffective parameter that is used to extract the effective parameter.

The natural language understanding portion a12 may extract a tool configured to express a relationship between words or between sentences, e.g., parse-tree.

The morphological analysis result, the domain information, the action information, the speech act information, the extracted parameter information, the entity name information and the parse-tree, which is the processing result of the natural language understanding portion a12 may be transmitted to the dialogue input manager a13.

The dialogue input manager a13 may transmit the natural language understanding result and context information to the dialogue manager 120.

The context information processor 131b may include a context information collector a21, a context information collection manager a22, and a context understanding portion a23.

The context information collector a21 may collect information from the second input device 120 and the controller 150.

The context information collector a21 may periodically collect data, or collect data only when a certain event occurs. In addition the context information collector a21 may periodically collect data and then additionally collect data when a certain event occurs. Further, when receiving a data collection request from the context information collection manager a22, the context information collector a21 may collect data.

The input except for the speech of the second input device 120 may be contained in the context information. That is, the context information may include the vehicle state information, the driving environment information and the user information.

The vehicle state information may include information, which indicates the vehicle state and is acquired by a sensor provided in the vehicle 1, and information that is related to the vehicle, e.g., the fuel type of the vehicle, and stored in the vehicle 1.

The driving environment information may be information obtained by the sensor provided in the vehicle a. The driving environment information may include image information acquired by a front camera, a rear camera or a stereo camera, obstacle information acquired by a sensor, e.g., a radar, a Lidar, an ultrasonic sensor, and information related to an amount of rain, and rain speed information acquired by a rain sensor.

The driving environment information may further include traffic state information, traffic light information, and adjacent vehicle access or adjacent vehicle collision risk information, which is acquired via Vehicle to Everything (V2X).

The user information may include information related to user state that is measured by a camera provided in the vehicle or a biometric reader, information related to a user that is directly input using the input devices 110 and 120 provided in the vehicle 1 by the user, information related to the user and stored in the external content server, and information stored in mobile devices connected to the vehicle 1.

The context information collection manager a22 may manage the collection of context information.

The context information collection manager a22 may collect necessary the context information through the context information collector a21, and transmit a confirmation signal to the context understanding portion a23.

When the context information collection manager a22 determines that a certain event occurs since data collected by the context information collector a21 meets a predetermined condition, the context information collection manager a22 may transmit an action trigger signal to the context understanding portion a23.

The context understanding portion a23 may understand the context based on the natural language understanding result and the collected context information.

The context understanding portion a23 may search a context understating table for searching for context information related to the corresponding event, and when the searched context information is not stored in the context understating table, the context understanding portion a23 may transmit a context information request signal to the context information collection manager a22, again.

The context understanding portion a23 may refer to context information for each action stored in the context understanding table to determine what context information is associated with performing an action corresponding to the user's utterance intention.

As illustrated in FIG. 5, the dialogue manager 132 may include a dialogue flow manager 132a, a dialogue action manager 132b, an ambiguity solver 132c, a parameter manager 132d, an action priority determiner 132e, and an external information manager 132f.

The dialogue flow manager 132a may request for generating, deleting and updating dialogue or action.

More particularly, the dialogue flow manager 132a may search for whether a dialogue task or an action task corresponding to the input by the dialogue input manager a13 is present in a dialogue and action state DB.

The dialogue and action state DB may be a storage space for managing the dialogue state and the action state, and thus the dialogue and action state DB 147 may store currently progressing dialogue and action, and dialogue state and action state related to preliminary actions to be processed. For example, the dialogue and action state DB 147 may store states related to completed dialogue and action, stopped dialogue and action, progressing dialogue and action, and dialogue and action to be processed.

When the domain and the action corresponding to a user utterance is not extracted, the dialogue and action state DB may generate a random task or request that the dialogue action manager 132b refers to the most recently stored task.

When the dialogue task or action task corresponding to the input of the input processor 131 is not present in the dialogue and action state DB, the dialogue flow manager 132a may request that the dialogue action manager 132b generates new dialogue task or action task.

When the dialogue flow manager 132a manages the dialogue flow, the dialogue flow manager 132a may refer to a dialogue policy DB.

The dialogue policy DB may store a policy to continue the dialogue, wherein the policy may represent a policy for selecting, starting, suggesting, stopping and terminating the dialogue.

In addition, the dialogue policy DB may store a point of time in which a system outputs a response, and a policy about a methodology. The dialogue policy DB may store a policy for generating a response by linking multiple services and a policy for deleting previous action and replacing the action with another action.

When the dialogue task or action task corresponding to the output of the input processor 131 is present in the dialogue and action state DB, the dialogue flow manager 132a may request that the dialogue action manager 132b refers to the corresponding dialogue task or action task.

The dialogue action manager 132b may generate, delete and update dialogue or action according to the request of the dialogue flow manager 132a.

The dialogue action manager 132b may designate a storage space to the dialogue and action state DB and generate dialogue task and action task corresponding to the output of the input processor 131.

When it is impossible to extract a domain and an action from the user's utterance, the dialogue action manager 132b may generate a random dialogue state. In this case, as mentioned later, the ambiguity solver 132c may identify the user's intention based on the content of the user's utterance, the environment condition, the vehicle state, and the user information, and determine an action appropriate for the user's intention.

The ambiguity solver 132c may deal with the ambiguity in the dialogue or in the context. For example, when anaphora, e.g., the person, that place on yesterday, father, mother, grandmother, and daughter-in-law, is contained in the dialogue, there may be ambiguity because it is not clear that the anaphora represents whom or which. In this case, the ambiguity solver 132c may resolve the ambiguity by referring to the context information DB, a long-term memory or a short-term memory or provide a guidance to resolve the ambiguity.

The ambiguity solver 132c may integrate the surrounding environment information and the vehicle state information together with the user's utterance even if the user's utterance or context is ambiguous, and accurately identify and provide the action the user actually wants or the action the user actually needs.

The ambiguity solver 132c may transmit information about the determined action to the dialogue action manager 132b. In this case, the dialogue action manager 132b may update the dialogue and action state DB based on the transmitted information.

The parameter manager 132d may manage the parameters needed for the action execution.

The parameter manager 132d may search for a parameter used to perform each candidate action (hereinafter refer to action parameter) in an action parameter DB.

The parameter value obtained by the parameter manager 132d may be transmitted to the dialogue action manager 132b and the dialogue action manager 132b may update the dialogue and action state DB by adding the parameter value according to the candidate action to the action state.

The parameter manager 132d may obtain parameter values of all of the candidate actions or the parameter manager 132d may obtain only parameter values of the candidate actions which are determined to be executable by the action priority determiner 132e.

The parameter manager 132d may selectively use an initial value among a different type of initial values indicating the same information. For example, the necessary parameter used for the route guidance may include the current position and the destination, and the alternative parameter may include the type of route. An initial value of the alternative parameter may be stored as a fast route.

The action priority determiner 132e may determine whether an action is executable about a plurality of candidate actions, and determine the priority of the plurality of candidate actions.

The action priority determiner 132e may search the relational action DB to search for an action list related to the action or the event contained in the output of the input processor 131, and then the action priority determiner 125 may extract the candidate action.

The relational action DB may indicate actions related to each other, a relationship among the actions, an action related to an event and a relationship among the events. For example, the route guidance, the vehicle state check, and gasoline station recommendation may be classified as the relational action, and a relationship there among may correspond to an association.

The extracted candidate action list may be transmitted to the dialogue action manager 132b and the dialogue action manager 132b may update the action state of the dialogue and action state DB by adding the candidate action list.

The action priority determiner 132e may search for conditions to execute each candidate action in an action execution condition DB. The action priority determiner 132e may transmit the execution condition of the candidate action to the dialogue action manager 132b and the dialogue action manager 132b may add the execution condition according to each candidate action and update the action state of the dialogue and action state DB.

The action priority determiner 132e may search for a parameter that is needed to determine an action execution condition (hereinafter refer to condition determination parameter), from the context information DB, the long-term memory, the short-term memory or the dialogue and action state DB, and determine whether it is possible to execute the candidate action, using the searched parameter.

The action priority determiner 132e may determine whether it is possible to perform the candidate action using the parameter used to determine an action execution condition. In addition, the action priority determiner 132e may determine the priority of the candidate action based on whether to perform the candidate action and priority determination rules stored in the dialogue policy DB.

The action priority determiner 132e may provide the most needed service to a user by searching for an action directly connected to the user's utterance and context information and an action list related thereto, and by determining a priority therebetween.

The action priority determiner 132e may transmit the possibility of the candidate action execution and the priority to the dialogue action manager 132b and the dialogue action manager 132b may update the action state of the dialogue and action state DB by adding the transmitted information.

The external information manager 132f may manage the external content list and related information, and manage factor information required for external content query.

As illustrated in FIG. 6, a result processor 133 may include a response generation manager 133a, a dialogue response generator 133b, an output manager 133c, a service editor 133d, a memory manager 133e, and a command generator 133f.

The response that is output by corresponding to the user's utterance or context may include the dialogue response, the vehicle control, and the external content provision. The dialogue response may include an initial dialogue, a question, and an answer including information. The dialogue response may be stored as database in a response template.

The response generation manager 133a may request that the dialogue response generator 133b and the command generator 133f generate a response that is needed to execute an action, which is determined by the dialogue manager 132.

For this, the response generation manager 133a may transmit information related to the action to be executed, to the dialogue response generator 133b and the command generator 133f wherein the information related to the action to be executed may include an action name and a parameter value. When generating a response, the dialogue response generator 133b and the command generator 133f may refer to the current dialogue state and action state.

The response generation manager 133a may transmit the dialogue response transmitted from the dialogue response generator 133b, to the output manager 133c.

The response generation manager 133a may also transmit the response transmitted from the dialogue response generator 133b, the command generator 133f, or the service editor 133d, to the memory manager 133c.

The dialogue response generator 133b may generate a response in text, image or audio type according to the request of the response generation manager 133a.

The dialogue response generator 133b may extract a dialogue response template by searching the response template, and generate the dialogue response by filling the extracted dialogue response template with the parameter value. The generated dialogue response may be transmitted to the response generation manager 133.

The output manager 133c may output the generated text type response, image type response, or audio type response, output the command generated by the command generator 133f, or determine an order of the output when the output is plural.

The output manager 133c may determine an output timing, an output sequence and an output position of the dialogue response generated by the dialogue response generator 133b and the command generated by the command generator 133f.

The output manager 133c may output a response by transmitting the dialogue response generated by the dialogue response generator 133b and the command generated by the command generator 133f to an appropriate output position at an appropriate order with an appropriate timing.

The output manager 133c may output Text to speech (TTS) response via the speaker 142 and a text response via the display 141. When outputting the dialogue response in the TTS type, the output manager 133c may use a TTS module provided in the vehicle 1 or alternatively the output manager 133c may include a TTS module.

The output manager 133c may output the dialogue response generated by the dialogue response generator 133b through the speaker 141.

According to a control target, the command may be transmitted to the controller 150 or the communication device 170 for communicating with the external content server.

The service editor 133d sequentially or sporadically executing a plurality of service and collection a result thereof to provide a service desired by a user.

The memory manager 133e managing the long-term memory and the short-term memory based on the output of the response generation manager 133a and the output manager 133c.

The command generator 133f generating a command for the vehicle control or the provision of service using an external content according to a request of the response generation manager 133a.

The command generator 133f may generate the command for executing a response to the user's utterance or context when it includes the vehicle control or external content provision. For example, when the action determined by the dialogue manager 132 is a control of the air conditioner, the window, the seats, or the AVN, the command for executing the control may be generated and transmitted to the response generation manager 133a.

When there are a plurality of commands generated by the command generator 133f, the service editor 133d may determine a method and order of executing the plurality of commands and transmit them to the response generation manager 133a.

In addition, when the user inputs an utterance expressing emotion, the specific domain or action may not be extracted from the user's utterance, but the dialogue system 130 may grasp the user's intention using surrounding environment information, vehicle state information, and user state information, and the like, and develop the dialogue.

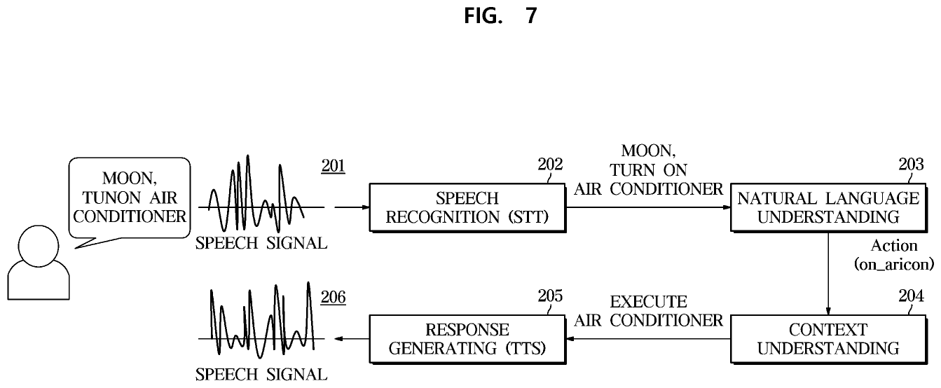

FIG. 7 is a control flowchart of a dialogue system according to an embodiment.

The dialogue system may receive the user's command by speech through the microphone (201). In this case, the dialogue system may receive sound and then convert the sound into the electrical signal (i.e., speech signal).

The dialogue system may recognize the user's speech based on the speech signal (202).

At this time, the dialogue system may convert the speech signal into utterance in the text type and recognize the user's intention by applying the natural language understanding algorithm to the user utterance.

More specifically, when the dialogue system converts the speech signal to utterance in the text type, the dialogue system may correct the utterance in the text type according to the user's intention and context rather than converting it as it is.

For example, when the user utters ‘Moon, tunon the air conditioner’, the dialogue system may be corrected with the text ‘Moon, turn on the air conditioner’, which can be understand by the dialogue system, based on information stored in the STT DB 134a, without converting it to the text ‘Moon, tunon the air conditioner’.

That is, the dialogue system may select the speech signal having the highest similarity among at least one or more speech signals identified and identify text matching the selected speech signal.

In addition, the dialogue system may identify at least one or more speech signals having a degree of similarity or higher than the identified speech signal among speech signals in the STT DB 134a, identify texts corresponding to the identified at least one or more speech signals, and then select one of the texts corresponding to the user's intention and context.

In this way, the dialogue system may correct the speech of the inaccurate pronunciation with the text for the speech of the accurate pronunciation by comparing the speech signal in the STT DB 134a with the speech-recognized speech signal, and may correct the text for the nonstandard language to text for the standard language.

In addition, the dialogue system may determine whether the converted text is text for inaccurate pronunciation based on the user's intention and context. When it is determined that the converted text is text for inaccurate pronunciation, the dialogue system may correct the converted text to text with text for accurate pronunciation based on the information of the STT DB 134a, and the user's intention and context.

In addition, the dialogue system may determine whether the converted text is text for the nonstandard language based on the user's intention and context. When it is determined that the converted text is text for the nonstandard language, the dialogue system may correct the converted text to text for the standard language based on the information of the STT DB 134a, and the user's intention and context.

For example, when the user utters ‘Moon, tunon the air conditioner’, the dialogue system may be corrected with the text ‘Moon, turn on the air conditioner’, which can be understand by the dialogue system, based on information stored in the STT DB 134a, weather conditions, and the operation condition of the air conditioner, without converting it to the text ‘Moon, tunon the air conditioner’.

The dialogue system may identify the user's intention contained in the utterance by applying natural language understanding to the utterance, perform morpheme analysis on the utterance in the text type, and then extract the domain from the utterance based on the morpheme analysis result. In other words, the dialogue system may perform natural language understanding (203).

The dialogue system may analyze the speech act of the utterance to analyze the intention of the user's utterance, identify the intention of the user's utterance based on the information, e.g., domain, entity name, and speech act corresponding to the utterance, and determine the action corresponding to the intention of the user's utterance.

The dialogue system may also receive user commands received through the user's manipulation, images of the user captured by the camera, and receive vehicle state information to grasp the user's intention or context. In other words, the dialogue system may collect information related to the vehicle state or driving environment in addition to the user's speech, and use the collected information to understand the context (204).

The dialogue system may generate the response necessary to perform the determined action (205). In this case, the dialogue system may extract the dialogue response template by searching the response template, and generate the dialogue response by filling the extracted dialogue response template with the parameter value.

At this time, the response may be generated as the response in text, image or audio type.

The dialogue system may output the TTS response through the speaker 142 (206).

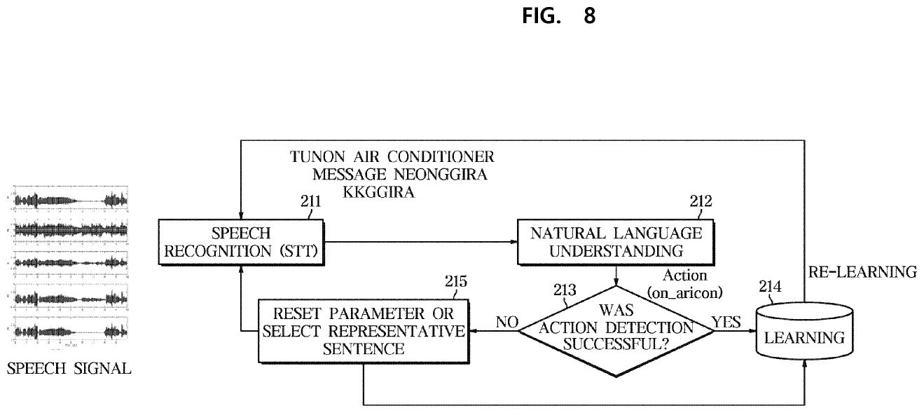

FIG. 8 is a flowchart of learning control of a dialogue system according to an embodiment, and is a control flowchart for the dialogue system capable of learning.

The dialogue system may receive the user's command by speech through the microphone. In this case, the dialogue system may receive the sound and then convert the sound into the electrical signal (i.e., speech signal).

The dialogue system may recognize the user's speech based on the speech signal (211).

At this time, the dialogue system may convert the speech signal into utterance in the text type and recognize the user's intention by applying the natural language understanding algorithm to the user utterance.

More specifically, when the dialogue system converts the speech signal to utterance in the text type, the dialogue system may correct the utterance in the text type according to the user's intention and context rather than understanding it as it is.

That is, the dialogue system may select the speech signal having the highest similarity among at least one or more speech signals, identify the text matching the selected speech signal, and then correct the utterance based on the identified text.

In addition, the dialogue system may identify the text corresponding to the received speech signal based on the information stored in the STT DB 134a. In this case, the dialogue system may further perform the operation of identifying the standard language corresponding to the identified text when it is determined that the identified text corresponds to the nonstandard language or the inaccurate pronunciation.

For example, when the user utters ‘message neonggira’, the dialogue system may correct with the text ‘leave a message’, which can be understood by the dialogue system, based on the information stored in the STT DB 134a, without directly converting it to the text ‘message neonggira’.

The dialogue system may identify the user's intention contained in the utterance by applying natural language understanding to the utterance, perform morpheme analysis on the utterance in the text type, and then extract the domain from the utterance based on the morpheme analysis result. In other words, the dialogue system may perform natural language understanding (212).

The dialogue system may analyze the speech act of the utterance to analyze the intention of the user's utterance, identify the intention of the user's utterance based on the information, e.g., domain, entity name, and speech act corresponding to the utterance, and determine whether or not the action detection corresponding to the intention of the user's utterance is successful (213).

The dialogue system may generate the response necessary to perform the detected action when it is determined that the action detection is successful. In this case, the dialogue system may extract the dialogue response template by searching the response template, and generate the dialogue response by filling the extracted dialogue response template with the parameter value.

Determining that the action detection is successful may refer to that the text information for the nonstandard language or incorrect speech is stored in the STT DB 134a, so that the action corresponding to the corrected text is successfully detected.

The dialogue system may output the TTS response through the speaker 142.

The dialogue system may update the information stored in the STT DB 134a based on the speech recognition result. That is, the dialogue system may additionally store the speech signal for the recognized speech and the selected text in the STT DB 134a. In this way, the dialogue system may perform text correction learning on the recognized speech signal.

The dialogue system may additionally store the speech signal for the recognized speech and the selected text in the STT DB 134a, but may also store information about the detected action.

When it is determined that the dialogue system has failed to detect the action, the dialogue system may select the speech signal having the highest similarity among the speech signals in the STT DB 134a, identify the text matching the selected speech signal, and store the identified text and speech signals together in the STT DB 134a.

Determining that the action detection has failed refers that the action detection corresponding to the corrected text has failed because the information of the text for the nonstandard language or incorrect speech is not stored in the STT DB 134a.

In addition, when it is determined that the dialogue system has failed to detect the action, the dialogue system may reset the parameters for the speech signal and text in the STT DB 134a and store the reset speech signal and text in the STT DB 134a (215).

Here, resetting the parameters for the speech signal and the text may include receiving text corresponding to the speech signal from the user through the second input device 120, and receiving the accurate pronunciation of the utterance or the standard language of the utterance as a second speech through the first input device 110.

The dialogue system may perform learning to convert speech for the inaccurate pronunciation and speech for the nonstandard language into text by changing, deleting, and adding information stored in the STT DB 134a.

As is apparent from the above description, according to the dialogue system, the vehicle having the same, and the method of controlling the dialogue system, it may be possible to improve a recognition rate of speech recognition and provide the service that is appropriate for the user's intention or that is needed for the user by precisely recognizing the user's intention based on a variety of information such as dialogue with the user and vehicle state information, driving environment information, and user information during the vehicle drives.

It may be possible to improve the accuracy of the dialogue system by changing an utterance of a nonstandard language such as an inaccurate speech or dialect into a vocabulary suitable for the dialogue system through STT (Speech To Text) optimized for the dialogue system.

It may be possible to propose a control of at least one function among a plurality of functions provided in the vehicle while conducting a dialogue through speech recognition for an inaccurate utterance and speech recognition for utterance of the nonstandard language such as dialect, and to enable a smooth dialogue between the system and a plurality of speakers.

Through the dialogue function, it may be possible to improve the quality of the vehicle, increase the commerciality, increase the satisfaction of the user, and improve the convenience of the user and the safety of the vehicle.

The disclosed embodiments may be implemented in the form of a recording medium storing computer-executable instructions that are executable by a processor. The instructions may be stored in the form of a program code, and when executed by a processor, the instructions may generate a program module to perform operations of the disclosed embodiments. The recording medium may be implemented non-transitory as a computer-readable recording medium.

The non-transitory computer-readable recording medium may include all kinds of recording media storing commands that can be interpreted by a computer. For example, the non-transitory computer-readable recording medium may be, for example, ROM, RAM, a magnetic tape, a magnetic disc, flash memory, an optical data storage device, etc.

Embodiments of the disclosure have thus far been described with reference to the accompanying drawings. It should be obvious to a person of ordinary skill in the art that the disclosure may be practiced in other forms than the embodiments as described above without changing the technical idea or essential features of the disclosure. The above embodiments are only by way of example, and should not be interpreted in a limited sense.

What is claimed is:

1. A dialogue system comprising:
a storage configured to store information about a standard language corresponding to a nonstandard language and a language of inaccurate pronunciation;
a speech recognizer configured to receive a speech signal, to convert the received speech signal into text, and to correct the converted text into text of the standard language based on information stored in the storage when it is determined that the converted text corresponds to the nonstandard language or the inaccurate pronunciation; and
a result processor configured to generate a response corresponding to the corrected text by the speech recognizer, and to control an output of the generated response.

2. The dialogue system according to claim 1, further comprising:
a first input device configured to receive the speech signal,
wherein:
the storage is configured to store information about text corresponding to a plurality of speech signals; and
the speech recognizer is configured to convert the received speech signals into text based on information stored in the storage.

3. The dialogue system according to claim 2, further comprising:
a natural language understanding portion configured to identify an intention of a user's utterance based on the text converted by the speech recognizer, and to determine an action corresponding to the identified intention of the user's utterance,
wherein, when it is determined that the action is not determined in the natural language understanding portion, the speech recognizer is configured to identify similarities between the received speech signal and the plurality of speech signals stored in the storage, respectively, and to identify text corresponding to the speech signal higher than a certain similarity among the identified similarities.

4. The dialogue system according to claim 2, further comprising:
a natural language understanding portion configured to identify an intention of a user's utterance based on the text converted by the speech recognizer, and to determine an action corresponding to the identified intention of the user's utterance,
wherein, when it is determined that the action is not determined in the natural language understanding portion, the speech recognizer is configured to identify similarities between the received speech signal and the plurality of speech signals stored in the storage, respectively, and to identify text corresponding to the speech signal having the highest similarity among the identified similarities.

5. The dialogue system according to claim 1, further comprising:
a natural language understanding portion configured to identify an intention of a user's utterance based on the text corrected by the speech recognizer, and to determine an action corresponding to the identified intention of the user's utterance,
wherein the result processor is configured to generate a response corresponding to the determined action, and to convert text corresponding to the generated response into the speech signal.

6. The dialogue system according to claim 1, further comprising:
a second input device configured to receive at least one of user input, vehicle state information, driving environment information, or user information;
a situation information processor configured to determine the user's context based on at least one information received by the second input device; and
a natural language understanding portion configured to identify an intention of a user's utterance based on the text corrected by the speech recognizer, and to determine an action corresponding to the identified intention of the user's utterance and the user's context,
wherein the result processor is configured to generate a response corresponding to the determined action, and to convert text corresponding to the generated response into the speech signal.

7. The dialogue system according to claim 6, wherein the speech recognizer is configured to determine whether the converted text corresponds to the nonstandard language or the inaccurate pronunciation based on the identified intention of the user's utterance and the user's context.

8. A vehicle comprising:
a first input device configured to receive a speech signal;
a second input device configured to receive at least one of user input, vehicle state information, driving environment information, or user information;
a storage configured to store text corresponding to each of a plurality of speech signals and information about a standard language corresponding to each text; and
a dialogue system configured to:
convert the received speech signal into text of the standard language based on the information stored in the storage,
identify an intention of the user's utterance based on the converted text,
determine the user's context based on at least one information received by the second input device,
determine an action corresponding to the identified intention of the user's utterance and the determined user's context,
generate a response corresponding to the determined action, and
output the generated response,
wherein the text corresponding to each of the plurality of speech signals comprises text in the standard language, text in a nonstandard language, and text in a language of inaccurate pronunciation.

9. The vehicle according to claim 8, further comprising:
a display configured to output the generated response as an image; and
a speaker configured to output the generated response as audio.

10. The vehicle according to claim 8, further comprising:
a controller configured to control at least one of an air conditioner, windows, doors, seats, an audio/video/navigation (AVN), a heater, a wiper, side mirrors, internal lamps, or external lamps in response to the response output from the dialogue system.

11. The vehicle according to claim 8, wherein, when it is determined that the action has not been determined, the dialogue system is configured to identify similarities between the received speech signal and the plurality of speech signals stored in the storage, respectively, to identify text corresponding to the speech signal higher than a certain similarity among the identified similarities, and to determine the action for the identified text.

12. The vehicle according to claim 11, wherein the dialogue system is configured to store information about the determined action and the identified text in the storage when the action for the identified text is determined.

13. The vehicle according to claim 8, wherein the dialogue system is configured to store information about the determined action and the converted text in the storage when an action for the converted text is determined.

14. A method of controlling a dialogue system comprising:
receiving a speech signal;
converting the received speech signal into text in standard language based on information stored in a storage;
identifying an intention of the user's utterance based on the converted text;
determining an action corresponding to the identified intention of the user's utterance and the converted text;
generating a response corresponding to the determined action; and
outputting the generated response as the speech signal,
wherein:
the information stored in the storage is information about text corresponding to each of a plurality of speech signals and standard language corresponding to each text; and
the text corresponding to each of the plurality of speech signals comprises text in the standard language, text in a nonstandard language, and text in a language of inaccurate pronunciation.

15. The method according to claim 14, wherein the determining of the action comprises:
receiving at least one of user input, vehicle state information, driving environment information, or user information;
determine the user's context based on the received at least one information;
identifying the intention of the user's utterance based on the converted text; and
determining the action corresponding to the identified intention of the user's utterance and the determined user's context.

16. The method according to claim 14, further comprising:
when it is determined that the action has not been determined, identifying similarities between the received speech signal and the plurality of speech signals stored in the storage, respectively;
identifying text corresponding to the speech signal higher than a certain similarity among the identified similarities;
determining the action for the identified text; and
storing information about the determined action and the identified text in the storage when the action for the identified text is determined.

17. The method according to claim 14, wherein the generating of the response comprises:
generating the response to control at least one of an air conditioner, windows, doors, seats, an audio/video/navigation (AVN), a heater, a wiper, side mirrors, internal lamps, or external lamps provided in a vehicle.
